(19) United States
(12) Patent Application Publication
(10) Pub. No.: US 2008/0187039 A1
(43) Pub. Date: Aug. 7, 2008

(54) Method And Apparatus For Correcting Video Signal

(75) Inventors: Daqing Zhang, Shanghai (CN); Jiagang Zhang, Shanghai (CN); Jin Wang, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/814,813

(22) PCT Filed: Jan. 18, 2006
(86) PCT No.: PCT/IB06/50180

§ 371 Date: Jul. 26, 2007

(30) Foreign Application Priority Data
Jan. 28, 2005 (CN) 200510005109.5

(51) Int. Cl. H04N 11/02

(52) U.S. Cl. 375/240.01; 375/E07.076

(57) ABSTRACT

The present invention discloses a method of correcting a video signal that includes a video sequence parameter. The method comprises the steps of: obtaining a specific number of decoded values of the video sequence parameter; counting the times of occurrence of each different value of the decoded values; determining a correction value from the counting result; and correcting the decoded values of the video sequence parameter on the basis of the correction value. The present invention further discloses a correcting apparatus and a decoding apparatus of a video signal. With the present invention, it is able to find out conveniently a correction value of a video sequence parameter so as to correct the subsequent decoded values.

### FIELD OF THE INVENTION

The present invention relates to a method and an apparatus for correcting a digital signal, and more particularly, to a method and an apparatus for correcting a video signal.

### BACKGROUND OF THE INVENTION

In the digital TV (SDTV/HDTV) and multimedia applications, a wide range of video compression standards has emerged to satisfy their numerous requirements, mainly for low bit rates and good quality. Bit errors (random errors and burst errors) of coded video streams frequently result in de-synchronization of a decoding process, which becomes unable to decode until the next resynchronization point. So it is very important to correct the decoded video signal.

In a standard coded video bit-stream, a video sequence layer includes a start code that can be used for a decoder to re-capture synchronization when coding/decoding de-synchronization occurs due to bit errors or other reasons. Thus, one de-synchronization will lead to loss of at least one slice of data. A sequence means a picture sequence that forms a program of a specific channel. A sequence header following the start code of the sequence includes a horizontal size, a vertical size, a frame rate and other information of the picture. And a sequence extension includes some additional data.

Parameters in the sequence header serve as basis to decode all the following data in the whole sequence. Wrong horizontal size and vertical size decoded from a damaged sequence header will cause serious visual degradation. In addition, in the scenario of DVD, the frame rate is a fixed value. If the frame rate is mapped into another value, which may be legal in the sense of the syntax of the standard, such an error would also deteriorate the visual result, especially when the specific application requires its value to be fixed.

U.S. Pat. No. 6,597,741 has disclosed a video correcting apparatus and method, which corrects corrupted sequence header information with an estimated picture size. A compressed digital video signal received by the video correcting apparatus contains a sequence header and at least one coded picture. Coded video sequence parameters included in the sequence header are decoded and stored in a memory. A video decoding process is performed on the coded picture. During this process a first macroblock count is produced, which first macroblock count represents the number of macroblocks contained in the decoded picture, and the decoding process is suspended. A second macroblock count is then determined from picture size data in the memory and compared with the first macroblock count. The video decoding process is resumed immediately by using the stored video sequence parameters after the first and second macroblock counts are determined to be equal to each other. Otherwise, the video sequence parameters in the memory are corrected with data representing an estimated picture size, and then this decoding process is resumed.

European Patent No.EP613300 has disclosed an error correcting scheme based on a previous right sequence header, while WO0106795 has disclosed an error correcting scheme based on a subsequent right sequence header.

However, all the above schemes exist some problems, i.e., sometimes it is difficult to find out a correction value of a video sequence parameter, and thereby, it is unable to perform right correction on a decoded video signal.

### OBJECT AND SUMMARY OF THE INVENTION

It is an object of the present invention to provide a method and an apparatus for correcting a video signal, which are capable of determining easily a correction value of a video sequence parameter, thereby ensuring the correctness of the correction value employed for correcting a subsequent decoded value.

To achieve the object, the present invention provides a method of correcting a video signal that includes a video sequence parameter. This method comprises the steps of: obtaining a specific number of decoded values of the video sequence parameter; counting the times of occurrence of each different value of the decoded values; determining a correction value from the counting result; and correcting the decoded values of the video sequence parameter on the basis of the correction value.

The present invention further provides an apparatus for correcting a video signal that includes a decoded video sequence parameter. The correcting apparatus comprises: obtaining means for obtaining a specific number of decoded values of the video sequence parameter; counting means for counting the times of occurrence of each different value of the decoded values; determining means for determining a correction value from the counting result; and a correction module for correcting the decoded values of the video sequence parameter on the basis of the correction value.

Additionally, the present invention further provides an apparatus for decoding a video signal that includes a decoded video sequence parameter. The decoding apparatus comprises: a decoding module for decoding the video signal; and a correcting apparatus. The correcting apparatus comprises: obtaining means for obtaining a specific number of decoded values of the video sequence parameter; counting means for counting the times of occurrence of a value of the decoded values; determining means for determining a correction value from the counting result; and a correction module for correcting the decoded values of the video sequence parameter on the basis of the correction value.

With the present invention, it is able to ensure the correctness of a correction value used for correcting a subsequent decoded value of a video sequence parameter and thereby improve the visual result of a picture reproduced.

Other objects and advantages of the present invention will become apparent, and the present invention will be appreciated more comprehensively from the following description, taken in conjunction with the accompanying drawings, and the claims.

### BRIEF DESCRIPTION OF THE DRAWINGS

FIG. 1 shows the method of correcting a video signal according to an embodiment of the present invention; and

FIG. 2 shows the apparatus for correcting a video signal according to an embodiment of the present invention.

In all the accompanying drawings, the same reference numeral denotes a similar or identical feature and function.

### DESCRIPTION OF THE PREFERRED EMBODIMENTS

The preferred embodiments will be described below with reference to the drawings.

As is well known, no matter how parameters in a video sequence layer are encoded, the decoded values of these parameters keep constant in a single video application in most cases. On the other hand, in multiple video applications, a sequence header will often be transmitted repeatedly because of its importance and the requirement of applications.

Thus, it can be deemed that some decoded values, e.g., horizontal size, vertical size and frame rate of a picture, keep constant in adjacent video sequence headers. Then, a certain number of decoded values of this parameter can be collected from consecutive sequence headers and identified. The decoded value that occurs most frequently of the collected decoded values is determined as a correction value of this parameter. Then, the decoded value of a subsequent sequence header is corrected with this correction value.

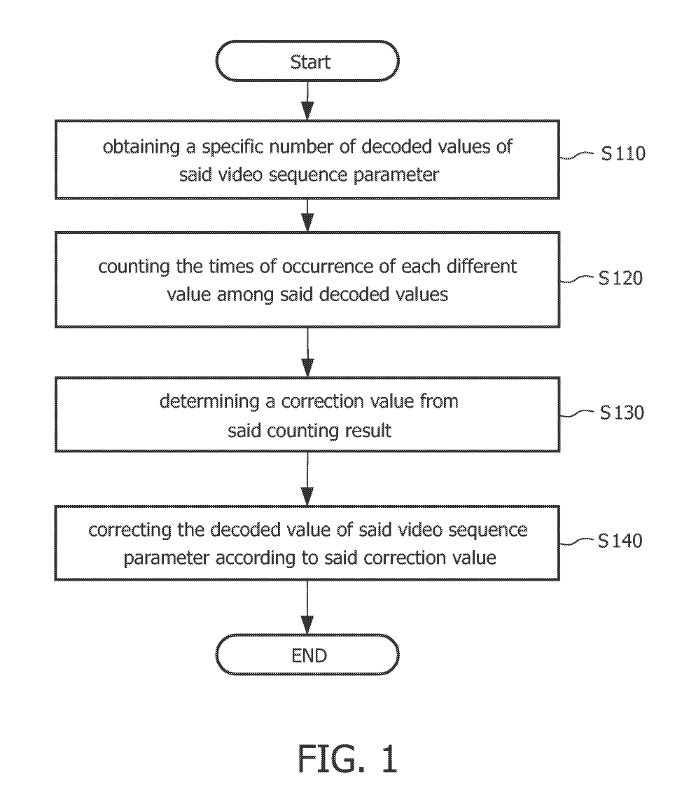

Referring to FIG. 1, the method of correcting a video signal according to an embodiment of the present invention will be described in detail, wherein this video signal contains a sequence header and at least one decoded picture, the sequence header includes at least one decoded video sequence parameter. The video sequence parameter contained in this sequence header includes a picture's horizontal size, vertical size, frame rate and the like.

A specific number of decoded values of the video sequence parameter are obtained in step S110.

This decoded video sequence parameter may be a picture's horizontal size, vertical size or frame rate. Received decoded values may be either successive or intermittent. A value of the number n of the received decoded values may be determined in accordance with the characteristics of the transmission bit error. That is, the higher the error-bit-rate is, the larger the value of n should be.

N decoded values of this decoded video sequence parameter in n sequence headers may be stored in a memory, or a window (e.g. a storage space within a memory) may be set to store n decoded values of a decoded video sequence parameter. The length of this window is n.

The times of occurrence of each different value of the decoded values are counted in step S120.

In this step, the times of occurrence of each decoded value of this specific number of decoded values are counted. For instance, where the received 10 decoded values are d1, d2, d1, d1, d3, d1, d1, d1, d2, d1, successively, thus, the decoded value d1 occurs seven times, the decoded value d2 occurs twice, and the decoded value d3 occurs once.

Next, a correction value is determined from the counting result in step S130, so as to correct the decoded values of the video sequence parameter.

The times of occurrence of each decoded values are compared to determine a decoded value, which has an occurrence-number not less than those of other decoded values, as the correction value.

A threshold m may be set, which is smaller than the specific number. If the number p of a decoded value contained of the specific number of decoded values of this decoded video sequence parameter is greater than or equal to the threshold m, this decoded value is determined as a correction value of this decoded video sequence parameter. Otherwise, the process returns to step S110 for re-receiving another set of decoded values of this decoded video sequence parameter until a correction value of this decoded video sequence parameter is found out.

The number of the another set of received decoded values may be equal to or greater than the specific number, whereas the threshold m may keep constant.

Similarly, the larger the threshold m is, the greater the reliability of the identified correction value of a decoded video sequence parameter is.

After a correction value of this decoded video sequence parameter is determined, the decoded value of this decoded video sequence parameter is corrected (step S140) with the correction value.

In other words, after a correction value of this decoded video sequence parameter is determined, a subsequent decoded value of this decoded video sequence parameter is checked. If this subsequent decoded value of this decoded video sequence parameter is found to be different from this correction value, then the subsequent decoded value is replaced by the correction value. Afterwards, the corrected decoded value is transmitted to a player to be played.

Alternatively, after the correction value is determined, the video signal may be re-decoded and transmitted to a player to be played after the decoded value thereof is corrected by the correction value.

In an embodiment according to the present invention, where the bit error rate of the video stream is very low, the specific number may be set as a relatively smaller value, e.g. 3, and the threshold m may be set to be 2. Of three consecutive sequence headers, if two decoded values of a decoded video sequence parameter are equal to each other, this decoded value can be adopted as the correction value to check corresponding decoded values in succeeding sequence headers.

In another embodiment according to the present invention, where the bit error rate of the video stream is high, the specific number may be set as a relatively larger value, e.g., 6, and the threshold m may be set to be equal to 4. Thus, of six consecutive sequence headers, if four decoded values of a decoded video sequence parameter are equal to one another, this decoded value can be adopted as the correction value to check corresponding decoded values in succeeding sequence headers.

In order to ensure that a correction value of a decoded video sequence parameter can be found correctly, the specific number n may be set to be large enough, e.g. 10, and the threshold m may be set to be equal to 8.

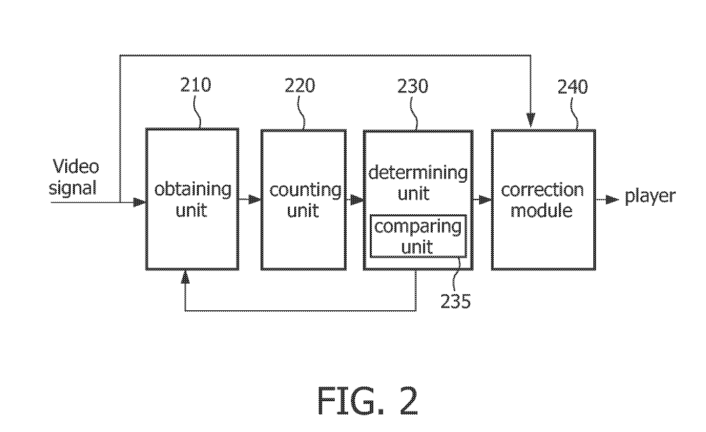

FIG. 2 shows an apparatus of correcting a video signal according to an embodiment of the present invention. This video signal contains a sequence header and at least one decoded picture, the sequence header including at least one decoded video sequence parameter. The decoded video sequence parameter may be a picture's horizontal size, vertical size, frame rate and the like.

As shown in FIG. 2, the correcting apparatus comprises obtaining unit 210, counting unit 220, determining unit 230 and correction module 240.

The obtaining unit 210 obtains from a decoding module (not shown) a specific number of decoded values of the video sequence parameter and transmits the obtained decoded values to the counting unit 220.

The counting unit 220 counts the time of occurrence of each different value of the decoded values, namely the times of repeated occurrence of each decoded value of the specific number of decoded values.

The decoded video sequence parameter may be a picture's horizontal size, vertical size or frame rate and the like. The received decoded values may be successive or intermittent. A value of the number n of the received decoded values may be determined in accordance with the characteristics of the transmission bit error. That is, the higher the error-bit-rate is, the larger the value of n should be.

The determining unit 230 determines a correction value from the counting result.

The determining unit 230 may comprise comparing unit 235 for comparing the times of occurrence of each the decoded values so as to determine a decoded value, which has an occurrence-number not less than those of other decoded values, as the correction value.

A threshold m smaller than the specific number may be pre-set in the comparing unit 235. If the number p of a decoded value contained in the specific number of decoded values of this decoded video sequence parameter is greater than or equal to the threshold m, this decoded value is determined as the correction value of this decoded video sequence parameter.

Otherwise, if there is no decoded value having a number greater than or equal to the threshold m, then the determining unit 230 notifies the obtaining unit 210 so that the obtaining unit 210 can re-receive another set of decoded values of this decoded video sequence parameter until the correction value of this decoded video sequence parameter is decided.

The number of another set of the received decoded values may be equal to or greater than the specific number, whereas the threshold m may keep constant.

The values of the parameter n and the threshold m may be determined according to the characteristics of the transmission bit error. That is, the higher the bit error rate is, the larger the values of n and m are. In return, the larger the values of n and m are, the greater the reliability of the identified correction value of a decoded video sequence parameter is.

After the correction value of this decoded video sequence parameter is determined, the determining unit 230 notifies the obtaining unit 210 so that the obtaining unit 210 does not receive any signal from the decoding module and transmits the determined correction value to the correction module 240.

After this correction value is received, the correction module 240 compares a subsequent decoded value of this video sequence parameter, which is received from the decoding module, with this correction value. If the subsequent decoded value received by the correction module 240 is different from this correction value, this decoded value is resumed as this correction value and then is transmitted to a player (not shown). If this decoded value of this video sequence parameter, which is received by the correction module 240, is equal to the correction module, no process will be performed on this decoded value.

Before the determining unit 230 determines the correction value of this decoded video sequence parameter, the correction module 240 may transmit the received decoded value of this video sequence parameter to the player directly.

Certainly, after the determining unit 230 determines the correction value of this decoded video sequence parameter, this video signal may be re-decoded and then transmitted to a player to be played after the correcting apparatus corrects the decoded value thereof.

In addition, according to another embodiment of the present invention, it further provides an apparatus of decoding a video signal. This decoding apparatus comprises a decoding module for decoding the video signal and a correcting apparatus as shown in FIG. 2. For concise, no details will be given to this correcting apparatus.

The present invention may be applied to MPEG video decoder, such as DVD/VCD players.

The present invention is described above taking the decoding of a digital video signal as an example. However, those skilled in the art shall well appreciate that the aforementioned embodiments are merely illustrative and do not limit the present invention. The present invention may further be applied to the process of other digital signal, such as decoding, decompressing and the like, provided that the video sequence parameter contained therein is a constant value.

Although the present invention has been described in terms of the presently preferred embodiment, it is to be understood that such a disclosure is not to be construed as limiting. Various alternations and modifications will no doubt become apparent to those skilled in the art having read the above disclosure. Accordingly, it is intended that the appended claims be interpreted as covering all alternations and modifications as falling into the true spirit and scope of the present invention.

1. A method of correcting a video signal that includes a video sequence parameter, the method comprising the steps of:
(a) obtaining a specific number of decoded values of the video sequence parameter;
(b) counting the times of occurrence of each different value of the decoded values;
(c) determining a correction value from the counting result; and
(d) correcting the decoded values of the video sequence parameter on the basis of the correction value.

2. The method as claimed in claim 1, wherein the video sequence parameter includes at least one of the parameters: horizontal size of video picture, vertical size of video picture and frame rate of video picture.

3. The method as claimed in claim 1, wherein the specific number is determined according to the transmission error characteristics of the video signal.

4. The method as claimed in claim 1, wherein step (c) further comprises:
(c1) comparing the times of occurrence of each of the decoded values so as to determine a decoded value, which has a time of occurrence not less than those of other decoded values, as the correction value.

5. The method as claimed in claim 1, wherein step (c) further comprises:
(c2) if one of the decoded values has a time of occurrence larger than a predetermined threshold, determining this decoded value as the correction value.

6. The method as claimed in claim 5, wherein the threshold is determined according to the transmission error characteristics of the video signal.

7. The method as claimed in claim 1, wherein in step (a), the specific number decoded values are consecutive decoded values.

8. A apparatus of correcting a video signal that includes a decoded video sequence parameter, comprising:
obtaining means for obtaining a specific number of decoded values of the video sequence parameter;
counting means for counting the times of occurrence of each different value of the decoded values;
determining means for determining a correction value from the counting result; and
a correction module for correcting the decoded values of the video sequence parameter on the basis of the correction value.

9. The apparatus as claimed in claim 8, wherein the video sequence parameter includes at least one of the parameters: horizontal size of video picture, vertical size of video picture and frame rate of video picture.

10. The apparatus as claimed in claim 8, wherein the specific number is determined according to the transmission error characteristics of the video signal.

11. The apparatus as claimed in claim 8, wherein the determining means further comprises:
comparing means for comparing the times of occurrence of each of the decoded values so as to determine a decoded value, which has a time of occurrence not less than those of other decoded values, as the correction value.

12. The apparatus as claimed in claim 8, wherein the determining means further comprises:
comparing means used for determining one of the decoded values as the correction value, if this decoded value has a time of occurrence larger than a predetermined threshold.

13. The apparatus as claimed in claim 12, wherein the threshold is determined according to the transmission error characteristics of the video signal.

14. An apparatus of decoding a video signal that includes a decoded video sequence parameter, the decoding apparatus comprising:
a decoding module for decoding the video signal; and
a correcting apparatus, the correcting apparatus comprising:
obtaining means for obtaining a specific number of decoded values of the video sequence parameter;
counting means for counting the times of occurrence of each different value of the decoded values;
determining means for determining a correction value from the counting result; and
a correction module for correcting the decoded values of the video sequence parameter on the basis of the correction value.

15. The apparatus as claimed in claim 14, wherein the video sequence parameter includes at least one of the parameters: horizontal size of video picture, vertical size of video picture and frame rate of video picture.

16. The apparatus as claimed in claim 14, wherein the determining means further comprises:
comparing means for comparing the times of occurrence of each the decoded values so as to determine a decoded value, which has a time of occurrence not less than those of other decoded values, as the correction value according to the counting result of the counting means.

17. The apparatus as claimed in claim 14, wherein the determining means further comprises:
comparing means used for determining one of the decoded values as the correction value, if this decoded value has a time of occurrence larger than a predetermined threshold.
